(19) United States
(12) Patent Application Publication
(10) Pub. No.: US 2006/0018120 A1
(43) Pub. Date: Jan. 26, 2006

(54) Illuminator and production method

(76) Inventors: Daniel Linehan, Wellington Road, Cork (IE); Sten Bjorsell, Cork (IE); Simon Stanley, Kilmacthomas (IE); William Kelly, Inishanon (IE)

Correspondence Address: BURNS & LEVINSON LLP, 1030 15TH STREET NW, SUITE 300, WASHINGTON, DC, 20005-1501, US

(21) Appl. No.: 10/532,356

(22) PCT Filed: Nov. 26, 2003
(86) PCT No.: PCT/IE03/00154

§ 371 Date: Apr. 20, 2005

(30) Foreign Application Priority Data
Nov. 26, 2002 (IE) 2002/0906

(51) Int. Cl. F21V 7/00

(52) U.S. Cl. 362/247; 362/294; 362/800; 257/98

(57) ABSTRACT

An illuminator (1) has an array of cavities (3) are drilled in a substrate having an FR4 electrically insulating body (7) plated with copper conductors (6(a), 6(b)). Further patterning of the substrate provided electrical conductors (3(b)) in the cavities to act as both part of the light drive circuit and reflectors in the cavities. The drilling is performed to the full depth of the FR4 body (7) until underneath plating (6(b)) is reached. A further Cu plating (4(b)) is applied on the platings (6(b)) so that they together form a heat spreader under each cavity (3). A layer (8) of resin incorporating thermally conductive particles is bonded to the underside surfaces, both of the FR4 (7) and of the platings (4(b)). A heat sink (9) is bonded to the layer (8). Good optical efficiency and thermal dissipation is achieved, despite the fact that conventional PCT processing techniques are used.

### INTRODUCTION

1. Field of the Invention

The invention relates to an illuminator and to a method for producing an illuminator.

2. Prior Art Discussion

Light emitting and infrared emitting diodes (referred to hereinafter as “LEDs” are widely used as indicators and as sources of illumination for a wide variety of applications. In order to ensure maximum efficiency, reliable operation, and a long lifetime it is necessary to take various measures in assembling the LEDs into packages or into housings such as are typically used in illuminators.

For the use of single or small numbers of LED dies, the through-pin package (“T-Pack”) has been developed. In this package the die sits in a metal reflective cavity which enables good optical efficiency by reflecting light from the sides of the chip towards a moulded lens intrinsic to the package. The thermal resistance of the package is acceptable for some applications, but limited by the length of the pins connecting it to the rest of the assembly. This T-pack, and surface-mount variations of it, has become commonplace for many applications.

There are also in existence techniques for manufacturing light arrays by for example using metallized plastic cavities, incorporating optical reflectors, such as are used for scanning sources in photocopying machines. These typically work well, but are not capable of achieving high LED densities.

For applications such as medical, machine vision, and signage, it is often desirable to try to locate a dense 1 or 2 dimensional array of LEDs close together. However, the physical dimensions of T-Packs or surface mount packages limit the densities which can be achieved.

An alternative approach is to work with bare dies, and mount them directly on a circuit substrate such as FR4, making electrical connections from the circuit to the back of the chips with conductive die-attach epoxy and/or to the front of the chips with wire bonding techniques. In this case a high density (for example. 4 dies per sq.mm. for 0.3 mm square dies) of LEDs and correspondingly high brightness can be achieved. If the chips are being operated at high current levels it may be necessary to reduce the thermal resistance of the assembly by using a thin ceramic substrate instead of FR4. However, in both of these cases, although there is an improvement in radiant energy density compared with the typically achievable densities with T-Pack or surface mount packages, the improvement is partially offset by an optical efficiency reduction due to loss of light emitted from the sides of the LED dies, which is not collected by lenses used in these assemblies. Also, the heat which is generated by the density of the LEDs can cause reliability problems, can reduce useful life, and can reduce optical efficiency.

JP62235787 describes an arrangement in which a metal substrate of good thermal conductivity has recesses, each containing a light source. To avoid electrical shorting problems and to provide circuit connectivity insulator layers and conductor elements are separately deposited both above and in the recesses. It appears that this arrangement leads to complexity for electrical circuit manufacture arising from the fact that the substrate is of metal.

This invention is therefore directed towards providing an illuminator and production method which enables a good density of LED sources to be achieved in an optically efficient manner, combined with low thermal resistance. Another object is to achieve this by using techniques which are compatible with common printed circuit board (PCB) manufacturing techniques, thus enabling cost effective manufacture to be achieved. Another object is to achieve improvements in highly collimated uniform light emission.

### SUMMARY OF THE INVENTION

According to the invention, there is provided an illuminator comprising an array of light sources mounted in cavities in a substrate, and an electrical drive circuit, wherein the substrate comprises an electrically insulating body plated with conductors for the drive circuit.

In one embodiment, the substrate body is of a circuit board material.

In another embodiment, the substrate body is of FR4 material.

In a further embodiment, the conductors extend into the cavities to also act as reflective coatings on the cavity walls.

In one embodiment, the conductors extend underneath the light sources.

In another embodiment, the light sources are bare semiconductor die.

In a further embodiment, the illuminator further comprises a thermally conductive structure under the light sources.

In one embodiment, the thermally conducting structure comprises a plurality of layers bonded to a surface of the substrate body.

In another embodiment, the thermally conductive structure comprises a heat spreader in direct contact with a plating under a light source.

In a further embodiment, the heat spreader comprises a metal plating patterned onto the substrate under each cavity.

In one embodiment, heat spreader comprises a plurality of metal coatings patterned onto the substrate, one under the other.

In another embodiment, there is one heat spreader per light source.

In a further embodiment, the thermally conducting structure comprises a global thermally conducting layer underneath all of the cavities.

In one embodiment, said global layer comprises a resin embedded with thermally conductive particles.

In another embodiment, the particles are of diamond material.

In a further embodiment, the particles are of a ceramic material such as Boron Nitride.

In one embodiment, the thermally conductive structure further comprises a heat sink bonded to the global layer.

According to another aspect there is provided a method of producing an illuminator comprising the step of:
providing a substrate body of insulating material,
completing a substrate by plating the body with an electrically conductive plating;
forming an array of cavities in the substrate at a top side, the cavities having a shape for desired light reflection; and
placing a light source in each cavity.

In one embodiment, the plating of the substrate is patterned after the cavity-forming step to both provide the drive circuit and optically reflective coatings on the walls of the cavities.

In another embodiment, the substrate is plated with metal on an underside, and each cavity is formed through the full depth of the substrate body to expose the plating on the underside.

In a further embodiment, the cavities are formed by drilling.

In one embodiment, the invention comprises the further steps of applying a thermally conductive structure to the underside of the substrate.

In another embodiment, the thermally conductive structure is applied to the platings under the cavities and exposed substrate surfaces therebetween.

In a further embodiment, an additional metal layer is applied to the platings before application of the thermally conductive structure.

In one embodiment, the thermally conductive structure comprises a layer of resin impregnated with thermally conductive particles.

In another embodiment, a heat sink is applied to said layer.

In a further embodiment, the heat sink and the resin layer are applied with use of adhesives and pressing.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagrammatic cross-sectional side view of a part of an illuminator circuit of the invention; and

FIG. 2 is a diagrammatic cross-sectional view of a part of an alternative illuminator for an outdoor signage application.

### DESCRIPTION OF THE EMBODIMENTS

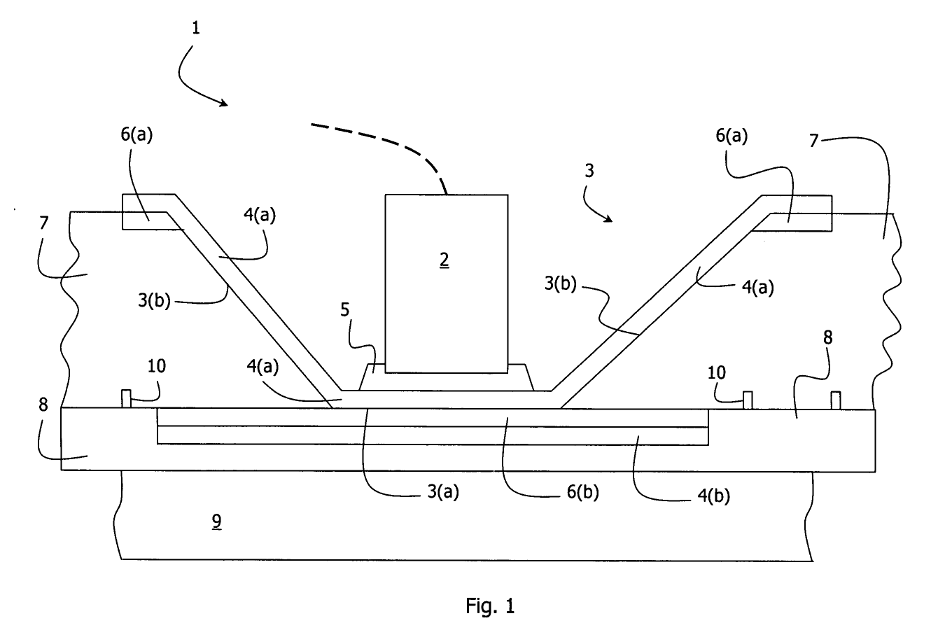

The invention provides an illuminator comprising an array of bare die LEDs with a close packing density, good thermal diffusion, and high optical efficiency. The illuminator is manufactured using conventional circuit board manufacturing techniques and materials and so excellent manufacturing efficiency can be achieved. One light unit 1 of the illuminator is shown in FIG. 1, the others being similar and being manufactured simultaneously.

An LED 2 is mounted in a cavity 3 having a round shape in plan, a flat circular base 3(a) and a tapered side wall 3(b). The cavity 3 is formed in an FR4 substrate 7 and is coated with a reflective coating 4(a). The reflective coating is also a conductor forming part of the drive circuit of the illuminator. The LED 2 is secured to the cavity base 3(a) by conductive adhesive 5. The reflective coating 4(a) extends over the Cu conductor plating 6(a) around the rim of the cavities 3.

The substrate 7 is an FR4 printed circuit board having top Cu plating 6(a) and bottom Cu plating 6(b).

A high thermal conductivity prepreg layer 8 is bonded to the bottom surfaces of the substrate 7 and platings 6(b) and 4(b). The substrate 7 has small cavities or wells 10 in its bottom surface to accommodate excess adhesive when the layer 8 is being bonded. Such wells may be avoided if the copper 6(b) pattern on the underside of the body 7 is such as to provide the same effect. A heat sink 9 is bonded to the layer 8 underneath the LEDs 2 by thermally conductive epoxy.

The process for producing the illuminator is as follows. These steps simultaneously manufacture the full illuminator with all of the light sources in an array.
(a) The substrate 7 comprising the FR4 body and the platings 6(a) and 6(b) is provided. In a pre-processing step these coatings 6(a) and 6(b) are deposited in a desired pattern using conventional circuit board manufacturing techniques. The substrate 7 is drilled with tapered drill bits conforming to the shape of the cavity 3. A lubrication is used to provide a smooth finish. Drilling is continued through the full depth of the FR4 body of the substrate 7 until the drill bit exposes the lower Cu plating 6(b).
(b) The base 3(a) and the tapered side wall 3(b) of the cavity 3, and the underneath coating 4(b) are then coated using conventional PCB conductor patterning steps including plating through holes in PCBs. In this embodiment, the plating sequence is 20-40 microns of matt Cu, a thin layer of bright Cu, 2-5 microns of bright nickel, and a sub-micron layer of gold. Other alternative reflective coatings will be known by those skilled in the art.
(c) The plating 6(a) and 6(b) is then etched to form the desired final circuit patterns for connectivity of the LEDs 2 and other components. This final pattern outside of the cavities may alternatively be made in the initial substrate preparation stage when the platings 6(a) and 6(b) are being deposited on the FR4 board.
(d) The layer 8 and the heat sink 9 are then applied using adhesives and a pressing operation performed with insertion of a support in the cavities 3. The heat sink 9 is an anodising layer. A support may alternatively be avoided if plating thickness and geometry provide sufficient strength for pressing. An important aspect of the layer 8 is that it has high thermal conductivity for dissipation of heat to the heat sink 9. The layer 8 comprises a prepreg resin with embedded diamond particles at a concentration in excess of 30% to achieve good thermal conductivity. The thermal conductivity is of the order of 120-140 W/m° C. In other embodiments, ceramic particles such as Boron Nitride may be used instead.
(e) Finally, the LEDs 3 are placed on the bases 3(a) with thermally conductive adhesive deposits 5.

It will be appreciated that the invention achieves use of standard PCB processing techniques and materials to achieve excellent reflectivity, heat dissipation, and connectivity requirements of an LED array in a simple and compact manner. The configuration of the cavities 3 can be chosen in a versatile manner to suit the particular application, a drill bit with a different profile being used. The bonding and pressing operations achieve excellent physical strength together with the desired heat dissipation to the heat sink 9. The adhesive 5, the reflective (metal) coating 4(a), the base Cu copper 6(b), the coating 4(b), and the layer 8 provide excellent thermal conductivity to the heat sink 9. Indeed, it is envisaged that the heat sink may be dispensed with for some configurations and/or light sources. Heat dissipation is particularly assisted by virtue of the fact that the layers 6(b) and 4(b) act together as a heat spreader for fast dissipation from the LEDs.

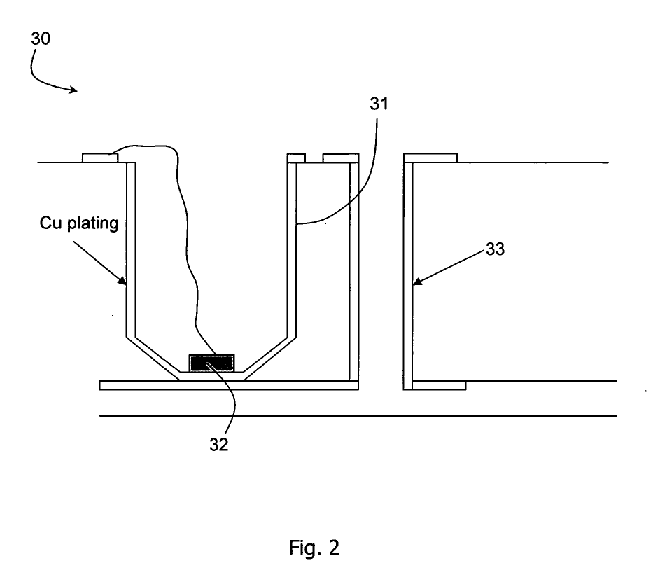

Referring to FIG. 2 an illuminator 30 has deep cavities 31 so that there is a large degree of internal reflection of light emitted by the LEDs 32. The side walls of the cavities 31 are deep enough to act like a shield from external light such as strong sunshine. This avoids the need for external mechanical shields, thus reducing costs and complexity. This illuminator is particularly suitable for applications such as roadside signs, where there is considerable ambient light. The construction under the LEDs 32 is similar to that shown in FIG. 1, these details being omitted from FIG. 2.

It will be appreciated that the invention achieves a high light source density, excellent optical output and efficiency, and excellent heat dissipation despite the fact that conventional PCB processing techniques and materials are used. Heretofore, the approach has been to try to obtain the above combination of desired optical properties while accepting that expensive manufacturing techniques and materials are necessary.

The invention is not limited to the embodiments described but may be varied in construction and detail. For example the PCB may be multi-layer, incorporating plating internally, and possibly also internally incorporating a layer such as the layer 8. Also, the substrate body may be of any suitable material other than FR4. An important criterion is that the material is of a type which can be drilled to expose a smooth surface which can accept a reflector layer. There may be vacuum deposition of parts. The layers underneath the light sources may be of a different materials having a high thermal conductivity. Also, the cavity may be filled or partially filled with phosphorescent material, such as for producing white light from a blue source. It is also envisaged that a lens may be mounted within the field of emission of the LED, possibly using an over-moulding process. The cavity may have a different shape such as frusto-pyrmadial, parabolic, elliptical, or hyperbolic for example. The shape is in general chosen for optimum reflectivity. High thermal conductivity particles other than diamond or ceramics may be used in a resin layer. Also, the heat spreaders may compromise a material similar to that of the global layer 8.

1. An illuminator comprising an array of a plurality of light sources mounted in a plurality of cavities in a substrate, and an electrical drive circuit, wherein the substrate comprises an electrically insulating body plated with plural conductors for the drive circuit.

2. An illuminator as claimed in claim 1, wherein the electrically insulating body is of a circuit board material.

3. An illuminator as claimed in claim 2, wherein the electrically insulating body is of FR4 material.

4. An illuminator as in claim 1, wherein the plural conductors extend into the plural cavities, whereby said plural conductors act as reflective coatings on the plural cavity walls.

5. An illuminator as claimed in claim 4, wherein the plural conductors extend underneath the light sources.

6. An illuminator as claimed in claim 1, wherein the plural light sources comprise bare semiconductor dies.

7. An illuminator comprising an array of a plurality of light sources mounted in a plurality of cavities in a substrate, an electrical drive circuit, wherein the substrate comprises an electrically insulating body plated with plural conductors for the drive circuit, and a thermally conductive structure under the plural light sources.

8. An illuminator as claimed in claim 7, wherein the thermally conductive structure comprises a plurality of layers bonded to a surface of the substrate body.

9. An illuminator as claimed in claim 8, wherein the thermally conductive structure comprises at least one heat spreader in direct contact with a plating under a light source.

10. An illuminator as claimed in claim 9, wherein the heat spreader comprises a metal plating patterned onto the substrate under each cavity.

11. An illuminator as claimed in claim 9, wherein heat spreader comprises a plurality of metal coatings patterned onto the substrate, one under the other.

12. An illuminator as claimed in claim 9, wherein the at least one heat spreader comprises one heat spreader per light source.

13. An illuminator as claimed in claim 7, wherein the thermally conducting structure comprises a global thermally conducting layer underneath all of the cavities.

14. An illuminator as claimed in claim 13, wherein said global layer comprises a resin embedded with thermally conductive particles.

15. An illuminator as claimed in claim 14, wherein the particles are of diamond material.

16. An illuminator as claimed in claim 14, wherein the particles are of a ceramic material.

17. An illuminator as claimed in claim 16 wherein the ceramic material is Boron Nitride.

18. An illuminator as claimed in claim 13, wherein the thermally conductive structure further comprises a heat sink bonded to the globally conducting layer.

19. An illuminator as claimed in claim 7, wherein the electrically insulating body is of a circuit board material.

20. An illuminator as in claim 19, wherein the electrically insulating body is of FR4 material.

21. An illuminator as in claim 7, wherein the plural conductors extend into the plural cavities, whereby said plural conductors act as reflective coatings on the plural cavity walls.

22. An illuminator as claimed in claim 21, wherein the plural conductors extend underneath the light sources.

23. An illuminator as claimed in claim 7, wherein the plural light sources comprise bare semiconductor dies.

24. A method of producing an illuminator comprising the step of:
providing a substrate body of insulating material,
completing a substrate by plating the body with an electrically conductive plating;
forming an array of cavities in the substrate at a top side, the cavities having a shape for desired light reflection; and
placing a light source in each cavity.

25. A method as claimed in claim 24, wherein the plating of the substrate is patterned after the cavity-forming step to both provide the drive circuit and optically reflective coatings on the walls of the cavities.

26. A method as claimed in claim 24, wherein the substrate is plated with metal on an underside, and each cavity is formed through the full depth of the substrate body to expose the plating on the underside.

27. A method as claimed in Claim 24, wherein the cavities are formed by drilling.

28. A method as claimed in claim 25, comprising the further steps of applying a thermally conductive structure to the underside of the substrate.

29. A method as claimed claim 28, wherein the thermally conductive structure is applied to the platings under the cavities and exposed substrate surfaces therebetween.

30. A method as claimed in claim 29, wherein an additional metal layer is applied to the platings before application of the thermally conductive structure.

31. A method as claimed in claim 29, wherein the thermally conductive structure comprises a layer of resin impregnated with thermally conductive particles.

32. A method as claimed in claim 31, wherein a heat sink is applied to said layer.

33. A method as claimed claim 32, wherein the heat sink and the resin layer are applied with use of adhesives and pressing.
